(19) United States
(12) Patent Application Publication
(10) Pub. No.: US 2024/0351824 A1
(43) Pub. Date: Oct. 24, 2024

(54) METHOD FOR OPERATING AN ELEVATOR SYSTEM, COMPUTER DEVICE

(71) Applicant: TSG Technische Service Gesellschaft mbH, Erfurt (DE)

(72) Inventors: Sebastian WALTHER, Rackwitz (DE); Alexander HEß, Leipzig (DE); Hannes WEDEMEYER, Leipzig (DE)

(21) Appl. No.: 18/629,025

(22) Filed: Apr. 8, 2024

(30) Foreign Application Priority Data
Apr. 18, 2023 (DE) 10 2023 109 710.5

(51) Int. Cl. B66B 5/00

(52) U.S. Cl. CPC B66B 5/0037

(57) ABSTRACT

The application relates to a method for operating an elevator system having a traction sheave drive, wherein the elevator system has at least one traction sheave, a support cable guided via the traction sheave, a car, and a counterweight connected to the car by means of the support cable. It is provided that at least one or respectively one acceleration (\ddot{x}) of the car and/or the counterweight is acquired during downward travel and/or upward travel, and that a mass ratio (V) of car mass (P) to counterweight mass (G) and/or a load balance (L) of the elevator system (1) is determined as a function of the acceleration (\ddot{x}).

### CROSS REFERENCE TO RELATED APPLICATION

This application claims the benefit of German Application No. 10 2023 109 710.5, filed on Apr. 18, 2023, the entire disclosure of which is hereby incorporated herein by reference.

### FIELD OF THE INVENTION

The invention relates to a method for operating an elevator system having a traction sheave drive, wherein the elevator system has at least one traction sheave, a support cable guided via the traction sheave, a car, and a counterweight connected to the car by means of the support cable.

The invention also relates to a computer device that is specifically designed to carry out the method according to the invention.

### BACKGROUND OF THE INVENTION

Elevator systems of the type mentioned at the beginning are known from the prior art. Such elevator systems are usually checked at regular intervals for their operational safety. For example, the traction capacity of the traction sheave is determined and it is checked whether this is sufficient. For example, from patent specification DE 10 2006 042 909 B4 of the applicant, a method for testing the traction capacity of such elevator systems is known, wherein the traction capacity is assessed as sufficient and the elevator system passes the test if a predetermined test condition is met. It is provided that the traction sheave is decelerated upwards in rapid travel of the car, and that a maximum braking acceleration occurring during deceleration on the counterweight, car, and/or support cable is acquired. The masses of the counterweight and car are required for the formula disclosed there for determining the traction capacity by means of deceleration measurement. Specifically, the test condition used comprises a mass ratio of car mass to counterweight mass. These masses are usually determined by complex measurements by means of appropriate weighing devices.

### BRIEF SUMMARY OF THE INVENTION

The invention is based on the object of creating an alternative, improved method for determining measured variables usually collected when testing elevator systems, in particular the mass ratio mentioned above, which is carried out with reduced measuring and computing effort.

The object on which the invention is based is achieved by a method having the features of claim 1. According to the invention, it is provided that at least one or respectively one acceleration of the car and/or the counterweight is acquired during downward travel and/or upward travel, and that a mass ratio of car mass to counterweight mass and/or a load balance of the elevator system is determined as a function of the acceleration. This creates a particularly advantageous possibility for determining the mass ratio mentioned at the beginning as well as a load balance, which is also usually determined when testing elevator systems, in which, in contrast to the methods mentioned at the beginning, a complex measurement of the car mass and the counterweight mass is dispensed with. The method according to the invention therefore reduces the testing effort enormously. The invention is based on the finding that the mass ratio is alternatively advantageously determined simply by acceleration measurement or deceleration measurement.

According to a preferred refinement of the invention, it is provided that when determining the mass ratio and/or load balance, a compensation factor for a frictional force arising during acceleration due to slipping of the support cable on the traction sheave is taken into consideration, wherein the compensation factor k is in particular a rational number k>1, k=2, or k>2. The compensation factor has the advantage that the exact effect of the frictional force does not have to be determined with great effort, but can be replaced with a sufficiently precise estimate with little effort.

Particularly preferably, it is provided that when determining the mass ratio and/or load balance, a number of the support cables is taken into consideration as a suspension divisor of the elevator system, wherein the suspension divisor is a natural number. This advantageously ensures that the method produces reliable results independently of the design of the elevator system. The suspension divisor insofar refers to the type of pulley arrangement used. If the support cable is only guided via the traction sheave, the suspension divisor is 1. For each pulley over which the support cable is guided, the suspension divisor increases by 1, so with an additional pulley it is 2. The number of support cables therefore does not refer to the number of support cables, but rather how many sections the same contiguous support cable is divided into by the pulley.

According to a preferred refinement of the invention, it is provided that the arithmetic mean of the acquired accelerations is taken into consideration when determining the mass ratio and/or load balance. If multiple accelerations are acquired, for example in upward and downward travel, and/or at the car and counterweight, the calculation of the arithmetic mean results in the advantage that the accuracy of determining the mass ratio and/or load balance is further improved. A sum of two acquired accelerations (e.g., upward and downward travel) is insofar halved, and a sum of four acquired accelerations (e.g., upward and downward travel, each on the car and counterweight) is quartered.

It is particularly preferably provided that the traction sheave is driven in order to move the car in a first direction of travel, in particular downwards, that the traction sheave is decelerated, in particular with a predetermined braking force, and that at least a first deceleration is acquired as acceleration. Acquiring a corresponding first deceleration in the first direction of travel advantageously ensures that the mass ratio and/or load balance are determined particularly easily.

According to a preferred refinement of the invention, it is provided that the traction sheave is driven in order to move the car in a second direction of travel opposite to the first direction of travel, in particular upwards, that the traction sheave is decelerated, in particular with the predetermined braking force, and that at least a second deceleration is acquired as acceleration. The additional acquisition of the corresponding second deceleration in the second direction of travel results in the advantage that the accuracy of determining the mass ratio and/or load balance is further improved.

Particularly preferably, it is provided that a height position of the car in its car shaft is specified as a function of an expected mass ratio, in particular at two-thirds of a total height of the car shaft, and that the traction sheave is decelerated at the specified height position. This advantageously ensures that the influence of the cable mass of the support cable on the result is minimized. The height position is calculated in particular as the product of the mass ratio and the maximum conveying height of the car.

According to a preferred refinement of the invention, it is provided that in order to acquire the acceleration from a static state of the elevator system, a braking device assigned to the traction sheave is released, so that the car is moved without a drive. This results in the advantage that the determination of the mass ratio and/or load balance is particularly simple because driving and decelerating the traction sheave are omitted.

Particularly preferably, it is provided that the mass ratio is determined by the equation

$$V = \frac{k \times \frac{{\sum }_{i = 1}^{b} \ddot{{x}_{i}}}{b}}{g ⨯ D} + 1$$

and/or the load balance is determined by the equation

$$L = \frac{k \times \frac{{\sum }_{i = 1}^{b} \ddot{{x}_{i}}}{b}}{g ⨯ D} ,$$

wherein k=compensation factor for frictional force, \ddot{x}=determined acceleration, b=number of accelerations, g=acceleration due to gravity, and D=suspension divisor. This creates a particularly advantageously simple way to determine the mass ratio and/or load balance.

According to a preferred refinement of the invention, it is provided that a traction capacity of the traction sheave is determined as a function of the determined mass ratio, in particular in upward travel according to the equation

$$T = V \times \frac{g + \ddot{x}}{g - \ddot{x}} ,$$

wherein g=acceleration due to gravity, and \ddot{x}=determined acceleration. This results in the advantage that the above-mentioned determination of the traction capacity is carried out particularly easily without knowledge of the actual masses. The acceleration is or comprises in particular one of the above-mentioned acquired decelerations in upward travel.

Particularly preferably, it is provided that a landing mass of the counterweight is acquired, that a cable mass of the support cable is determined, and that the car mass and/or the counterweight mass are determined as a function of the determined mass ratio, the cable mass, and the landing mass. This creates a particularly advantageously simple way of comparing the masses with their target values without actually measuring the masses directly.

According to a preferred refinement of the invention, it is provided that the cable mass is determined according to the equation S=h_{F}×n×m_{S}, and that the car mass is determined according to the equation

$$P = \frac{A - S}{V - 1}$$

and/or the counterweight mass is determined according to the equation

$$G = V \times P = V \times \frac{A - S}{V - 1} ,$$

wherein h_{F}=conveying height, n=number of cables, and m_{S}=specific cable weight. This creates a particularly advantageously simple way to determine the masses. In particular, the number of cables n corresponds to the product of the suspension divisor D and the number of support cables used. The conveying height refers in particular to a maximum possible height position of the car in its car shaft.

Particularly preferably, it is provided that a height position of the car in its car shaft is specified as a function of an expected mass ratio, in particular at two-thirds of a total height of the car shaft, and that as a function of a deviation from the height position, a correction value for the car mass and/or the counterweight mass is determined. The correction value advantageously ensures that an influence of the cable mass of the support cable on the result is at least largely eliminated.

According to a preferred refinement of the invention, it is provided that an actual height position is acquired, the correction value is determined according to the equation

$$Δ m = ( \frac{h}{V + 1} - {h}_{is} ) \times n \times {m}_{S} ,$$

wherein n=number of cables, and m_{S}=specific cable weight, and the correction value is added to the car mass and/or is subtracted from the counterweight mass. This creates a particularly advantageously simple way to determine the corrected masses.

The computer device having the features of claim 15 is characterized in that it is specially designed to carry out the method according to the invention. This results in the advantages already mentioned above.

### BRIEF DESCRIPTION OF THE DRAWINGS

Further advantages and preferred features and combinations of features result in particular from what has been described above and from the claims. The invention will be explained in more detail below with reference to the drawing. In the figures

FIG. 1 shows an elevator system, and

FIG. 2 shows an advantageous method for operating the elevator system.

### DESCRIPTION OF EXAMPLE EMBODIMENTS

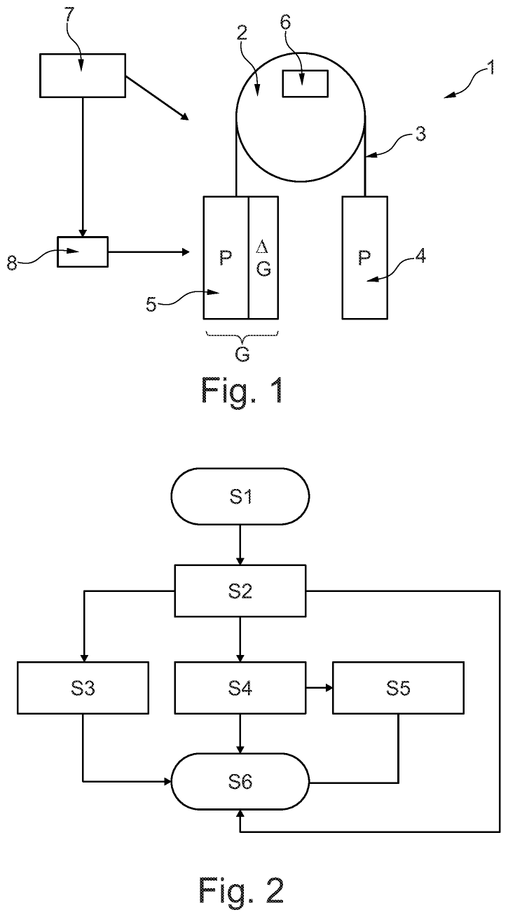

FIG. 1 shows a schematic representation of an elevator system 1 having traction sheave drive. The elevator system 1 has at least one drivable traction sheave 2, a support cable 3 guided over the traction sheave 2, a car 4, and a counterweight 5 connected to the car 4 by means of the support cable 3.

The traction sheave 2 is assigned a controllable braking device 6 for applying a specified braking force to the traction sheave 2 and thus for decelerating the traction sheave 2 in order to brake the car 4 and the counterweight 5 and hold them in a specified position.

In the present case, the elevator system 1 is furthermore assigned a computer device 7, for example as part of an external testing device for the elevator system 1. A sensor arrangement 8 is connected to the computer device 7 for communication purposes, which has, for example, an acceleration sensor and is designed to acquire an acceleration \ddot{x}, in particular deceleration, of the car 4 and/or the counterweight 5.

The car 4 has a car mass P (empty mass) and the counterweight 5 has a counterweight mass G, wherein the counterweight mass G is usually greater than the car mass P by a predetermined differential mass ΔG, for example half the payload, as indicated by a separation. The following thus applies: G=P+ΔG

If, starting from a static case in which the traction sheave 2 is blocked by the braking device 6 assigned thereto, so that car 4 and counterweight 5 are stationary, the braking device 6 is released (the brake is opened), then force resulting from the product of the differential mass Δ G of counterweight mass G and car mass P and the acceleration due to gravity (i.e., the known formula F=m×a) accelerates the balanced total elevator masses, which consist of the counterweight mass G and the car mass P. The resulting acceleration \ddot{x} can be acquired by means of the sensor arrangement 8.

An advantageous method for operating the elevator system 1 is described below with reference to FIG. 2. For this purpose, FIG. 2 shows the method using a flow chart. In particular, the method ensures that the elevator system is tested with little effort. The method is carried out in particular with the aid of the computer device 7 and the sensor arrangement 8.

The method is particularly advantageous if, as mentioned at the beginning, a traction capacity T of the elevator system 1 is to be determined. To determine and test the traction capacity T according to the patent of the applicant mentioned at the beginning by means of deceleration measurement, counterweight mass G and car mass P are required, as can be seen in the following equation:

$$T = \frac{G \times ( {g}_{n} \times \ddot{x} )}{P \times ( {g}_{n} - \ddot{x} )} = \frac{{S}_{2}}{{S}_{1}}$$

The invention is based on the finding that the mass ratio is alternatively advantageously determined simply by acceleration measurement or deceleration measurement. In this respect, it is not necessary to know the exact masses, so there is no need for complex weighing of the counterweight and cabin in particular.

The method begins with a step S1, in which at least one or respectively one acceleration k of the car 4 and/or the counterweight 5 is acquired during downward travel and/or upward travel.

In a first, simplest variant, in order to acquire the acceleration k from a static state of the elevator system 1, the braking device 6 assigned to the traction sheave 2 is released, so that the elevator car 4 is moved without a drive, as described above by way of example for FIG. 1.

As a function of a current height position of the car 4, the differential mass ΔG, and a cable mass S of the support cable 3, the car 4 is accelerated upwards or downwards. The acceleration \ddot{x} generated by the imbalance of the masses with the brake open and without a drive, which is, for example, an acceleration \ddot{x}_{P,ab} of the car mass P in downward travel, can be expressed for this acceleration case based on the generally known formula

$$a = \frac{F}{m}$$

by the following equation:

$$\ddot{x} = {\ddot{x}}_{P , ab} = \frac{( G - P ) \times g}{G + P}$$

The acceleration therefore only depends on the constant acceleration due to gravity g as well as the counterweight mass G and the car mass P.

If the elevator system 1 has further deflection rollers in addition to the traction sheave 2 shown in FIG. 1, it is thus suspended like a pulley 2:1 or the like, for example, the sum of the two masses G and P in the denominator has to be divided according to a ratio designated in the present case as the suspension divisor D in (G+P)/D. For example, the suspension divisor D has the value 2 in the case of 2:1, the value 4 in the case of 4:1, etc. The suspension divisor D enters the equation as follows by simplifying the equation in which the suspension divisor D is shifted into the numerator:

$$\ddot{x} = {\ddot{x}}_{P , ab} = \frac{( G - P ) \times g \times D}{G + P}$$

In order to minimize the influences of friction, mass inertia of the traction sheave and drive shaft, etc., it is advantageous if the acceleration \ddot{x} or deceleration is measured directly in the car shaft. Preferably, the brakes are not kept open, but rather the braking force, inertia, etc. are calculated out by equivalent braking in upward and downward travel. For this purpose, car 4 and counterweight 5 have to be in motion beforehand.

In a second variant, the traction sheave 2 is therefore driven in order to move the car 4 in a first direction of travel, downwards or upwards. The traction sheave 2 is then decelerated by the braking device 6, in the present case with a predetermined braking force. Finally, at least a first, in particular maximum, deceleration is acquired as acceleration \ddot{x}, namely a deceleration \ddot{x}_{P,ab} of the car mass P in downward travel, a deceleration \ddot{x}_{P,auf} of the car mass P in upward travel, a deceleration \ddot{x}_{G,ab} of the counterweight mass G in downward travel and/or a deceleration \ddot{x}_{G,auf} of the counterweight mass G in upward travel.

For example, only the car mass P is considered and the deceleration \ddot{x}_{P,ab} of the car mass P in downward travel is acquired first. Alternatively, only the counterweight mass G is considered and a deceleration \ddot{x}_{G,ab} of the counterweight mass G in downward travel is acquired.

Now the traction sheave 2 is driven to move the car 4 in a second direction of travel that is opposite to the first direction of travel, downwards or upwards. The traction sheave 2 is then decelerated, in this case again with the same predetermined braking force. Finally, at least a second, in particular maximum, deceleration, selected from the decelerations described above, is acquired as acceleration \ddot{x}.

For example, only the car mass P is considered and, in addition to the deceleration \ddot{x}_{P,ab} of the car mass P in downward travel, the deceleration \ddot{x}_{P,auf} of the car mass P in upward travel is acquired. Alternatively, only the counterweight mass G is considered and, in addition to the deceleration \ddot{x}_{G,ab} of the counterweight mass G in downward travel, the deceleration \ddot{x}_{G,auf} of the counterweight mass G in upward travel is acquired.

Preferably, a height position h of the car 4 in its car shaft is specified as a function of an expected mass ratio V, for example specified by the manufacturer, in particular at two-thirds of a total height of the car shaft, and the traction sheave 2 is decelerated in each case at the specifies height position h. This minimizes the influence of the cable mass of the support cable 3.

One journey in the upward direction is thus braked and one journey in the downward direction is decelerated with the same braking application, and the decelerations are measured, wherein the static forces still act, so that the relationships described for variant 1 still apply in principle. In this case, an average value of the acquired accelerations \ddot{x} is then formed in order to be able to use this in the above-mentioned equation.

It is to be noted that braking accelerations \ddot{x}_{Brems} that are not explicitly acquired and depend on the braking force act on the counterweight mass G and car mass P, which have to be added, namely a braking acceleration \ddot{x}_{G,auf,Brems} on the counterweight mass G in upward travel, a braking acceleration \ddot{x}_{G,ab,Brems} on the counterweight mass G in downward travel, a braking acceleration \ddot{x}_{P,auf,Brems} on the car mass P in upward travel and a braking acceleration \ddot{x}_{P,ab,Brems} on the car mass in downward travel.

However, because, as described above, the same braking forces act in each case, the corresponding braking accelerations cancel each other out, because the braking force when traveling upwards acts in a positive direction, i.e., in the direction of the acceleration due to gravity, and when traveling downwards it acts in a negative direction, i.e., against the acceleration due to gravity, so that the signs of the braking delays are opposite and balance out in tot.

If exclusively the car mass P is considered, the following equation results:

$$\ddot{x} = \frac{{\ddot{x}}_{P , ab} + {\ddot{x}}_{P , auf}}{2} = \frac{( G - P ) \times g \times D}{G + P}$$

If exclusively the counterweight mass G is considered, the following equation results:

$$\ddot{x} = \frac{{\ddot{x}}_{G , ab} + {\ddot{x}}_{G , auf}}{2} = \frac{( G - P ) \times g \times D}{G + P}$$

In a third variant based on the second variant, both the above-mentioned accelerations \ddot{x} on the car mass P and the accelerations \ddot{x} on the counterweight mass G are acquired. This averages spring-damper effects on both sides and further improves the accuracy of the result. The equation results:

$$\ddot{x} = \frac{{\ddot{x}}_{P , ab} + {\ddot{x}}_{P , auf} + {\ddot{x}}_{G , ab} + {\ddot{x}}_{G , auf}}{4} = \frac{( G - P ) \times g \times D}{G + P}$$

If the above-mentioned acquisition of the acceleration or accelerations \ddot{x} is completed, the method continues with a step S2. In step S2, as a function of the acquired acceleration(s) \ddot{x}, the previously discussed mass ratio V of car mass P to counterweight mass G and/or a load balance L of the elevator system 1 is determined.

Mathematically, this determination is restricted to a conversion of the equations mentioned above, solved for the acceleration \ddot{x}, to G/P, which corresponds to the mass ratio V. In the determination, as described above, a number of the supporting cables is taken into consideration as the suspension divisor D of the elevator system 1, wherein the suspension divisor D is a natural number. In addition, if multiple accelerations \ddot{x} have been acquired, the arithmetic mean of the acquired accelerations \ddot{x} is taken into consideration, so that the underlying equation appears in general form as follows:

$$\ddot{x} = \frac{{\sum }_{i = 1}^{b} {\ddot{x}}_{i}}{b} = \frac{( G - P ) \times g \times D}{G + P}$$

However, during dynamic measurements, additional forces occur when the support cable 3 slips during deceleration and overcomes the static friction. Then, at the time of slipping, an additional force F_{Z} acts, which has to be added to the term (G−P)×g×D in the numerator. In the extreme case, the additional force corresponds to F_{Z}=G×g.

The actual amount of additional force F_{Z} is unknown and depends largely on the coefficients of friction for static friction and clamping friction and the proportion of the slip time in the total braking time. This can only be determined with great effort.

A compensation factor k for a friction force arising during acceleration due to sliding of the support cable 3 on the traction sheave 2 is therefore taken into consideration in the determination of mass ratio V and/or load balance L, wherein the compensation factor k is in particular a rational number k>1, k=2, or k>2. The compensation factor k is chosen to compensate for the effective additional force F_{Z}. It has been shown that a sufficiently accurate estimate is achieved if the mass G+P to be decelerated, which corresponds to the denominator, is replaced by a product of the compensation factor k and the car mass P. The equation then reads:

$$\ddot{x} = \frac{{\sum }_{i = 1}^{b} {\ddot{x}}_{i}}{b} = \frac{( G - P ) \times g \times D}{k \times P}$$

It was possible to determine by practical tests that the effective additional force F_{Z} is compensated on average in particular when the mass to be decelerated G+P is reduced in the denominator by the differential mass G−P, so that the following applies: G+P−(G−P)=2×P. Transferred to the general case, this means that: k=2. This is an average value that is usually sufficiently accurate, especially when the drive is de-energized and recuperation is switched off. In principle, any value in the denominator can result as the effective mass to be decelerated, between complete slipping, which corresponds to approximately 1×P, and no slipping, which, as a function of the design, usually corresponds to approximately 2.3×P to 2.8×P (G+P).

Solving the above equation for the mass ratio V gives:

$$V = \frac{G}{P} = \frac{k \times \frac{{\sum }_{i = 1}^{b} {\ddot{x}}_{i}}{b}}{g \times D} + 1$$

As an example, the following results from variant 3, if k=2 is assumed:

$$V = \frac{G}{P} = \frac{2 \times \frac{{\ddot{x}}_{P , ab} + {\ddot{x}}_{P , auf} + {\ddot{x}}_{G , ab} + {\ddot{x}}_{G , auf}}{4}}{g \times D} + 1 = \frac{{\ddot{x}}_{P , ab} + {\ddot{x}}_{P , auf} + {\ddot{x}}_{G , ab} + {\ddot{x}}_{G , auf}}{2 \times g \times D} + 1$$

The first term on the right side corresponds to the so-called load balance L, which corresponds to the mass proportion by which the counterweight 5 is relatively heavier than the car 4, and which is therefore calculated according to the following equation:

$$L = \frac{k \times \frac{{\sum }_{i = 1}^{b} {\ddot{x}}_{i}}{b}}{g \times D}$$

The following results with variant 3 and k=2:

$$L = \frac{{\ddot{x}}_{P , ab} + {\ddot{x}}_{P , auf} + {\ddot{x}}_{G , ab} + {\ddot{x}}_{G , auf}}{2 \times g \times D}$$

By calculating the load balance L in this way, when testing the elevator system 1, it can be easily determined whether the car mass P and/or the counterweight mass G have been modified or manipulated without permission.

After determining the mass ratio V and/or load balance L, the method can be ended with step S6.

Alternatively, when the mass ratio V has been determined, in an optionally following step S3, as a function of the determined mass ratio V, a traction capacity T of the traction sheave 2 is determined, in particular in upward travel according to the equation known from the patent of the applicant cited at the beginning:

$$T = V \times \frac{g + \ddot{x}}{g - \ddot{x}}$$

Again alternatively or additionally, in particular in parallel, in an optionally following step S4, a landing mass A of the counterweight 5 is acquired, a cable mass S of the support cable 3 is determined, and as a function of the determined mass ratio V, the cable mass S, and the landing mass A, the actual car mass P and/or the counterweight mass G is determined.

The landing mass A is prepared by placing the counterweight 5 on a corresponding weighing device, for example as part of the sensor arrangement 8, wherein a drive assigned to the traction sheave 2 is neutral and the brakes of the braking device 6 are open. The landing mass A corresponds to the sum of the cable mass S and a so-called half load H, i.e., a mass difference between the counterweight mass G and the car mass P. The following applies:

$$A = H + S = ( G - P ) + S$$

By replacing the counterweight mass G with the product of the mass ratio V and the car mass P (V=G/P, correspondingly G=V×P applies), the following applies:

$$A = ( V \times P - P ) + S = P \times ( V - 1 ) + S$$

Solved for the car mass P, the following equation results:

$$P = \frac{A - S}{V - 1}$$

The counterweight mass G results according to the equation:

$$G = V \times P = V \times \frac{A - S}{V - 1}$$

The cable mass S can be determined from a product of a conveying height h_{F}, a number of cables n, and a specific cable weight m_{S}:

$$S = {h}_{F} \times n \times {m}_{S}$$

In this way, both the car mass P and the counterweight mass G can be advantageously easily determined with knowledge of the mass ratio V, the landing mass A, which is easier to determine metrologically, and the cable mass S. The method can now be ended with step S6.

Preferably, however, in a following optional step S5, the above-mentioned height position h is specified as a function of the expected mass ratio, and a correction value Δm for the car mass P and the counterweight mass G is determined as a function of a deviation from the height position h.

For this purpose, an actual height position hᵢₛₜ is acquired and the correction value is determined according to the following equation:

$$Δ m = ( \frac{h}{V + 1} - {h}_{ist} ) \times n \times {m}_{S}$$

Finally, the correction value is added to the car mass P and subtracted from the counterweight mass G, so that a corrected car mass Pₖₒᵣᵣ and a corrected counterweight mass Gₖₒᵣᵣ are determined:

$${P}_{korr} = P + Δ m , {G}_{korr} = G - Δ m$$

The process is now ended with step S6.

### LIST OF REFERENCE SIGNS

1 elevator system
2 traction sheave
3 suspension cable
4 car
5 counterweight
6 braking device
7 computer device
8 sensor arrangement
ΔG differential mass
Δm correction value for masses
A landing mass
b number of accelerations
D suspension divisor
F_{Z} additional force
g acceleration due to gravity
G counterweight mass
Gₖₒᵣᵣ corrected counterweight mass
H halfload
h specified height position
h_{F} conveying height
hᵢₛₜ actual height position
k compensation factor
L load balance
m_{S} specific cable weight
n number of cables
P car mass
Pₖₒᵣᵣ corrected car mass
S cable mass
T traction capacity
V mass ratio of car mass to counterweight mass
\ddot{x} acceleration
\ddot{x}_{Brems} braking acceleration
\ddot{x}_{G,ab} deceleration of the counterweight in downward travel
\ddot{x}_{G,ab,Brems} braking acceleration on counterweight in downward travel
\ddot{x}_{G,auf} deceleration of the counterweight in upward travel
\ddot{x}_{G,auf,Brems} braking acceleration on counterweight in upward travel
\ddot{x}_{P,ab} deceleration of the car in downward travel
\ddot{x}_{P,ab,Brems} braking acceleration on car in downward travel
\ddot{x}_{P,auf} deceleration of the car in upward travel
\ddot{x}_{P,auf,Brems} braking acceleration on car in upward travel

1. A method for operating an elevator system having a traction sheave drive, wherein the elevator system has at least one traction sheave, a support cable guided via the traction sheave, a car, and a counterweight connected to the car by means of the support cable,
wherein,
at least one or respectively one acceleration (\ddot{x}) of the car and/or the counterweight is acquired during downward travel and/or upward travel, and
as a function of the acceleration (\ddot{x}), a mass ratio (V) of car mass (P) to counterweight mass (G) and/or a load balance (L) of the elevator system is determined.

2. The method according to claim 1, wherein a compensation factor (k) for a friction force arising during acceleration due to sliding of the support cable on the traction sheave is therefore taken into consideration in the determination of mass ratio (V) and/or load balance (L), wherein the compensation factor k is in particular a rational number k>1, k=2, or k>2.

3. The method according to claim 1, wherein when determining the mass ratio (V) and/or load balance (L), a number of the supporting cables is taken into consideration as a suspension divisor (D) of the elevator system, wherein the suspension divisor (D) is a natural number.

4. The method according to claim 1, wherein the arithmetic mean of the acquired accelerations (\ddot{x}) is taken into consideration when determining the mass ratio (V) and/or load balance (L).

5. The method according to claim 1, wherein the traction sheave is driven in order to move the car in a first direction of travel, in particular downwards, in that the traction sheave is decelerated, in particular with a predetermined braking force, and in that at least a first deceleration (\ddot{x}_{P,ab}, \ddot{x}_{P,auf}, \ddot{x}_{G,ab}, \ddot{x}_{G,auf}) is acquired as acceleration (\ddot{x}).

6. The method according to claim 5, wherein the traction sheave is driven in order to move the car in a second direction of travel, which is opposite to the first direction of travel, in particular upwards, in that the traction sheave decelerates, in particular with a predetermined braking force and in that at least a first deceleration (\ddot{x}_{P,ab}, \ddot{x}_{P,auf}, \ddot{x}_{G,ab}, \ddot{x}_{G,auf}) is acquired as acceleration (\ddot{x}).

7. The method according to claim 5, wherein a height position (h) of the car in its car shaft is specified as a function of an expected mass ratio (V), in particular at two-thirds of a total height of the car shaft, and in that the traction sheave is decelerated at the specified height position (h).

8. The method according to claim 1, wherein in order to acquire the acceleration (\ddot{x}) from a static state of the elevator system, a braking device assigned to the traction sheave is released, so that the elevator car is moved without a drive.

9. The method according to claim 1, wherein the mass ratio (V) is given by the equation
$$V = \frac{k \times \frac{{\sum }_{i = 1}^{b} {\ddot{x}}_{i}}{b}}{g \times D} + 1$$
and/or the load balance (L) is determined by the equation
$$L = \frac{k \times \frac{{\sum }_{i = 1}^{b} {\ddot{x}}_{i}}{b}}{g \times D}$$
wherein k=compensation factor for friction force, \ddot{x}=determined acceleration, b=number of accelerations, g=acceleration due to gravity, and D=suspension divisor.

10. The method according to claim 1, wherein a traction capacity (T) of the traction sheave is determined as a function of the determined mass ratio (V), in particular in upward travel according to the equation
$$T = V \times \frac{g + \ddot{x}}{g - \ddot{x}}$$
wherein g=acceleration due to gravity, and \ddot{x}=determined acceleration.

11. The method according to claim 1, wherein a landing mass (A) of the counterweight is acquired, in that a cable mass (S) of the support cable is determined, and in that, as a function of the determined mass ratio (V), the cable mass (S), and the landing mass (A), the car mass (P) and/or the counterweight mass (G) can be determined.

12. The method according to claim 11, wherein the cable mass (S) is determined according to the equation
$$S = {h}_{F} \times n \times {m}_{S}$$
and in that the car mass (P) is determined according to the equation
$$P = \frac{A - S}{V - 1}$$
and/or the counterweight mass (G) is determined according to the equation
$$G = V \times P = V \times \frac{A - S}{V - 1}$$
wherein h_{F}=conveying height, n=number of cables, and m_{S}=specific cable weight.

13. The method according to claim 11, wherein a height position (h) of the car in its car shaft is specified as a function of an expected mass ratio, in particular at two-thirds of a total height of the car shaft, and in that, as a function of a deviation from the height position (h), a correction value (Δm) for the car mass (P) and/or the counterweight mass (G) is determined.

14. The method according to claim 13, wherein an actual height position (hᵢₛₜ) is acquired, in that the correction value is determined according to the equation
$$Δ m = ( \frac{h}{V + 1} - {h}_{ist} ) \times n \times {m}_{S}$$
wherein n=number of cables, and m_{S}=specific cable weight, and the correction value (Δm) is added to the car mass (P) and/or subtracted from the counterweight mass (G).

15. A computer device, wherein the computer device is specifically designed to carry out the method according to claim 1.
